(19) United States
(12) Patent Application Publication
(10) Pub. No.: US 2013/0060650 A1
(43) Pub. Date: Mar. 7, 2013

(54) METHOD AND A COMPUTER SYSTEM TO FACILIATE A PURCHASE OF AN ITEM ON A NETWORK-BASED MARKETPLACE

(71) Applicant: Johann HALLDORSSON, Gardabaer (IS)

(72) Inventor: Johann HALLDORSSON, Gardabaer (IS)

(21) Appl. No.: 13/225,814

(22) Filed: Sep. 6, 2011

(51) Int. Cl. G06Q 30/00

(52) U.S. Cl. 705/26.3

(57) ABSTRACT

This invention relates to a method and a computer system to facilitate a purchase of an item on a network-based marketplace. A proposed bid is received from a potential buyer to an item, the proposed bid including identification data (ID) identifying the item and a proposed-price for the item ID. The proposed bid is processed so as to identify potential sellers selling the item ID via the network-based marketplace. The proposed bid is forwarded to the identified potential sellers, and in case a target seller selected from these potential sellers agrees on the proposed-price and thus an actual selling price for said item ID, an acknowledgement message is issued informing the potential buyer that the target seller has accepted the proposed-price to the item ID.

### FIELD OF THE INVENTION

The present invention relates to a method and a computer system to facilitate purchasing an item on a network-based marketplace.

### BACKGROUND OF THE INVENTION

Many Internet-based auction facilities have been developed in the past several years. Through Internet-based auction facilities, potential sellers can enter information about their product or service for potential buyers to bid on. The information submitted by potential sellers is then organized and stored by the Internet-based auction facility. Potential buyers can search through the organized seller information to find products or services they wish to bid on. Once a buyer locates an item to bid on, the buyer can compete with other buyers for the item by submitting bids during a specified auction time period. At the end of the specified auction time period, the highest bid buyer is notified and the transaction between the seller and the highest bid buyer is facilitated.

While the current Internet-based auction facility works well for some items, there are several disadvantages. For example, it is not uncommon that users of such Internet-based auction sides experience fake auctions, where “sellers” are simply interested in finding out the value of certain products because the sellers are in no way committed towards the potential buyers. As an example, an owner of a car can initiate an Internet-auction for his car that may take several days or weeks without real intention of selling this car. A buyer that might be interested in the car may thus have to wait for days or weeks without getting any feedback from this fake seller and will never be informed whether this auction was a real auction or whether the seller was just someone interested in finding out possible selling price for this item. Also, some of the current auction methods allow the seller to influence the selling price by participating in the auction and in that way raise the selling price for this item.

In addition to this, current electronic commerce that utilizes the Internet to sell items require the potential buyer to browse through the internet to find the item or the seller of this item, which can sometimes be a very time demanding and tedious procedure.

To summarize this, current Internet-implemented methods are more or less focused on serving the interest of the sellers instead of serving the interest of the buyers.

The inventor of the present invention has appreciated that there is thus a need for a new method to facilitate on-line purchasing methods and make them more buyer oriented and has in consequence devised the present invention.

### SUMMARY OF THE INVENTION

It would be advantageous to achieve user-friendly way for facilitating purchasing an item on a network-based marketplace as via wired or a wireless network such as the Internet. In general, the invention preferably seeks to mitigate, alleviate or eliminate one or more of the above mentioned disadvantages singly or in any combination. In particular, it may be seen as an object of the present invention to improve current e-commerce methodology so as to facilitate a purchase of an item on a network-based marketplace that solves the above mentioned problems, or other problems, of the prior art.

To better address one or more of these concerns, in a first aspect of the invention a method is provided to facilitate a purchase of an item on a network-based marketplace, comprising:
i. receiving a proposed bid from a potential buyer to an item, the proposed bid including identification data (ID) identifying said item and a proposed-price for said item ID,
ii. processing said proposed bid so as to identify potential sellers selling said item ID via said network-based marketplace,
iii. forwarding said proposed bid to said identified potential sellers, and
iv. issuing, if a target seller selected from said potential sellers agrees on said proposed-price and thus an actual selling price for said item ID, an acknowledgement message informing said potential buyer that said target seller has accepted said proposed-price to said item ID.

Accordingly, a method is provided where all the methodology of the purchasing process is focused on serving the interest of the potential buyers instead of the potential sellers. Instead of guiding the potential buyer indirectly towards certain sellers that define in advance their item supply the potential buyer will now have a full control over the item definition. Therefore, the sellers have to adjust to the requirements set by the potential buyers and not vice verse. The result is that the potential buyer can request for all kinds of items irrespective of whether it has previously been offered by the sellers or not. Also, the user does no longer have to browse through the Internet in looking for potential sellers selling said item ID. Instead, these potential sellers can automatically be found since they are already registered at said network-based market place.

Based on the above, said method is very user friendly compared to many of the current on-line Internet auction methods. In addition to this, this method is not only of particular advantage for the buyer, but also for the sellers that may e.g. be experiencing cash problems and need to sell their products or are exchanging older products such as TVs with newer ones. Therefore, the time needed for the sellers to sell these products is not only enhanced but the costs that these sellers would otherwise have to invest in due to marketing and commercials may be strongly reduced. This method differs also from current Internet based on-line auction methods in that no information is being published about the sale acts of given sellers. In that way, the sellers can sell their items under a registered market price without jeopardizing contravening rivals or price fixing of other distributors. At the same time it is prevented that the sellers will find them selves in the position of not being able to keep up with demand where an item is e.g. being sold under the market price.

In one embodiment, said method further comprises automatically issuing a contract of sale certificate between the buyer and the target seller for said item ID indicating a legally binding obligation between them for said item ID. Therefore, a legally safe solution is provided for purchasing and selling said item ID and various item IDs via said network based market place where both the seller and the buyer of the item in commit themselves legal terms to this commerce.

In one embodiment, said proposed bid is further associated with a time frame indicator indicating the time said potential sellers have to respond to said proposed bid. In that way, the user knows when he/she can expect to get any reply to his/her bid offer and the waiting time until the potential buyer receives a conformation from said target seller is thus fixed meaning that the uncertainty when the potential buyer receives an answer to the proposed price is eliminated. The time frame indicator may in one embodiment be selected by said potential buyer. It is therefore no up to the potential buyer to decide how long time the potential sellers have to respond to this proposed bid and the potential buyer can thus customize this bidding process to his/her needs.

In one embodiment, said method further comprises storing said proposed-price for said item ID in a database along with previous proposed-prices for previous item IDs, the database being utilized as a guidance-database for guiding future potential buyers in selecting proposed-prices for various item IDs. In that way, all previous proposed-prices can be utilized for subsequent potential buyers in finding realistic propose-prices.

In one embodiment, the actual selling price for said item ID and previous item IDs are further associated to said item IDs at said guidance-database. In that way, by further including the actual selling prices the database becomes more detailed and better guidance is provided for the potential buyer to find the best bid for said item ID.

In one embodiment, prior to said step of receiving said proposed bid, the method further comprises:
presenting said potential buyer with plurality of item categories each of which includes multiple of item IDs so as to allow said potential buyer to browse through said item categories and said item IDs, said item IDs being associated with information from said guidance-database indicating previous proposed-prices and information indicating previous selling prices for said item IDs, and
receiving from said potential buyer said proposed-price for said item ID, where by confirming said proposed-price for said item ID by the potential buyer,
issuing and forwarding said proposed bid.

In that way, a very user friendly way is provided for potential buyers in firstly finding the item IDs that they are looking for and secondly in selecting bidding prices using the information from said guidance database.

In one embodiment, when browsing through said item categories the information from said guidance-database about the item IDs being browsed are automatically triggered and presented to the user. The user will thus automatically be provided with item related information when accessing certain item category such as previous selling prices or bidding prices or special offers. As an example, an item category can be 42′ Plasma TVs. By clicking on this item category the user can be presented with offers about previous bidding prices and/or selling prices by clicking on this item category.

In one embodiment, prior to said step of receiving said proposed bid, the method further comprises guiding said potential buyer through a payment gateway wherein said proposed-price is processed for determining whether the potential buyer fulfils pre-set payment criterion, where in case said pre-set payment criterion is fulfilled said potential buyer becomes committed to said proposed-price for said item ID. In that way, the seller has a guaranty that the potential buyer is good for the money.

In one embodiment, said step of processing the proposed bid comprises performing a match between said item ID selected by the potential buyer and said plurality of item IDs associated to said plurality of sellers, wherein those sellers having item IDs matching with said item ID selected by the potential buyer are considered as being said potential sellers.

In one embodiment, if none of said potential sellers agree on said proposed bid an automatic rejection-indicator is issued and forwarded to said potential buyer within a pre-defined time frame indicating that said proposed bid has not been accepted. In that way, the buyer will be notified within said pre-defined time frame if none of said potential sellers agreed on the bid, which makes the method very user friendly.

In one embodiment, the method further comprises requesting said buyer of said item ID for seller related feedback data indicating the reliability of the target seller, said seller related feedback data subsequently being associated to said target seller. This seller related feedback data may e.g. be a grade from 0-10, where 0 is the lowest grade and 10 is the highest grade. In that way, a measure is provided for all further potential buyers indicating the reliability of the target seller.

In one embodiment, the method further comprises requesting said target seller of said item ID about buyer related feedback data indicating the reliability of the buyer, said buyer related feedback data subsequently being associated to buyer ID data uniquely identifying the buyer of said item ID. Similarly as discussed above, this may e.g. be in a form of a grade in the scale 0-10. In that way, a measure is provided for all further target sellers indicating the reliability of the potential buyer.

In a second aspect of the invention, a machine-readable medium is provided having stored thereon data representing sequences of instructions, the sequences of instructions which, when executed by a processor, cause the processor to perform the steps of:
i. receiving a proposed bid from a potential buyer to an item, the proposed bid including identification data (ID) identifying said item and a proposed-price for said item ID,
ii. processing said proposed bid so as to identify potential sellers selling said item ID via said network-based marketplace,
iii. forwarding said proposed bid to said identified potential sellers, and
iv. issuing, if a target seller selected from said potential sellers agrees on said proposed-price and thus an actual selling price for said item ID, an acknowledgement message informing said potential buyer that said target seller has accepted said proposed-price to said item ID.

In a third aspect of the invention, a computer system is provided for facilitating a purchase of an item on a network-based marketplace, comprising:
i. a proposed bid receiving input-unit for receiving a proposed bid from a potential buyer to an item, the proposed bid including identification data (ID) identifying said item and a proposed-price for said item ID,
ii. a processor for processing said proposed bid so as to identify potential sellers selling said item ID via said network-based marketplace, and
iii. a proposed bid forwarding unit for forwarding said proposed bid to said identified potential sellers,
iv. a acknowledgement message issuing unit for issuing, if a target seller selected from said potential sellers agrees on said proposed-price and thus an actual selling price for said item ID, an acknowledgement message informing said potential buyer that said target seller has accepted said proposed-price to said item ID.

In one embodiment, the computer system further comprises a memory for storing said proposed price and said selling price and associating it to said item ID so as building up a guidance-database for various item IDs adapted for guiding future potential buyers in selecting proposed bid for various item IDs.

In one embodiment, the computer system further comprises:
a computer interface operate by a processor for presenting said potential buyer with at least one item ID prior to receiving said proposed bid from said potential buyer, said at least one item ID being associated with information from said guidance-database indicating previous selling prices or previous proposed-proposed prices or both for said item ID,
a receiving unit for receiving from said potential buyer said proposed-price for said item ID, and
proposed bid issuing unit for, when receiving an input command from said potential buyer confirming said proposed bid for said item ID by the potential buyer, issuing and forwarding said proposed bid and forwarding said proposed bid.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an exemplary embodiment of a method according to the present invention to facilitate a purchase of an item on a network-based marketplace,

FIG. 2 shows an exemplary embodiment of a method according to the present invention to implement the proposed prices and actual selling prices from the method in FIG. 1 to build up a database,

FIG. 3 shows an exemplary embodiment of a method according to the present invention assisting the potential buyer to select the item ID and the proposed price,

FIG. 4 shows an exemplary embodiment of a computer system according to the present invention for facilitating a purchase of an item on a network-based marketplace,

FIG. 5 is a basic diagrammatic presentation of buyers view when purchasing an item on a network-based market place,

FIG. 6a,b shows a diagrammatic presentation of sellers view,

FIG. 7 shows another diagrammatic presentation of buyers view when purchasing an item on a network-based market place depicting in a more detailed way an example of step-by-step approach at the buyers side, and

FIG. 8 shows another diagrammatic presentation of sellers view depicting in a more detailed way an example of step-by-step approach at the sellers side.

### DESCRIPTION OF EMBODIMENTS

Example methods and systems for purchasing items in network-based marketplace transactions are described. In the following description, for purposes of explanation, numerous specific details are set forth in order to provide a thorough understanding of example embodiments. It will be evident, however, to one skilled in the art that the present method and system may be practiced without these specific details.

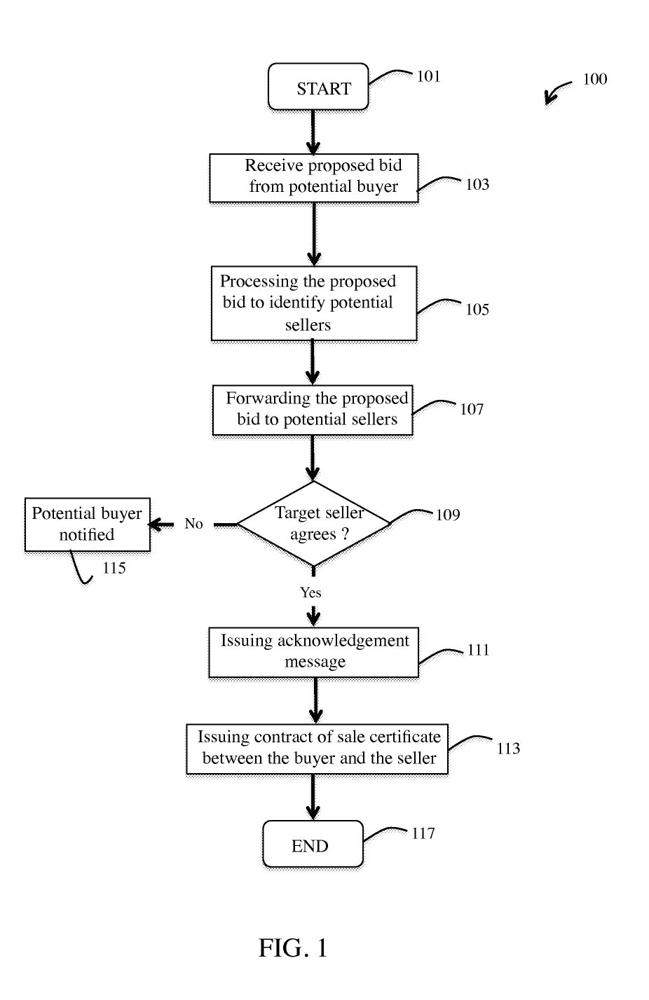

FIG. 1 shows an exemplary embodiment of a method 100 according to the present invention to facilitate a purchase of an item on a network-based marketplace. By the term network-based marketplace is according to the present invention meant sellers of items and buyers that are interlinked in a computerized way via a wired or wireless communication channel such as the Internet, Wide Area Network (WAN)), personal area networks (PANs), local area networks (LANs), campus area networks (CANs), or metropolitan area networks (MANs).

The method 100 commences at operation 101. At operation 103 a proposed bid is received from a potential buyer to an item, where the proposed bid includes identification data (ID) identifying the item and a proposed-price for the item ID. By the term item ID is meant data that uniquely indentify the item ID or item ID category. The item ID may e.g. be a particular brand of 42′ plasma TV and the proposed-price may be the initial bidding price for this 42′ plasma TV. The item ID may just as well stand for all 42′ plasma TVs without identifying the brand of the TV, or simply all 42′ TVs, without identifying whether it is plasma or LCD TVs. In one embodiment, the proposed bid is further associated with a time frame indicating the time the potential sellers have to respond to said proposed bid, which may e.g. be two weeks, or the potential buyer may be the one who determines this time frame so that it will be up to the potential buyer to decide how long time the potential sellers have to respond to this proposed bid.

At operation 105, the proposed bid is processed for identifying sellers selling the item ID via the network-based marketplace. In one embodiment, this may done by performing a match between the item ID selected by the potential buyer and the plurality of item IDs associated to the plurality of sellers. Those sellers that are selling the item IDs matching with this item ID selected by the potential buyer are considered as being the potential sellers. Referring to the example above, assuming that the item ID of the 42′ plasma TV is ID1234, all the sellers that are selling ID1234, e.g. plasma TVs, are found via this matching. Thus, in this operation 105, tens or hundreds of sellers that are selling ID1234 vie e.g. the Internet are automatically identified.

At operation 107, the proposed bid is forwarded the potential sellers that have been identified under operation 105. This may e.g. be in a form of an email message where all these potential sellers receive an email message containing the item ID information along with the bidding-price for this item ID.

If the result is at operation 109 is that a target seller selected from these potential sellers agrees on this proposed-price and thus an actual selling price for the item ID, an acknowledgement message is issued at operation 111 informing the potential buyer that the target seller has accepted the proposed-price to the item ID. Issuing this acknowledgement message may be done at the target seller side and sent directly to the buyer, or via third party that is informed by the target seller that the item ID has been sold, by e.g. sending the buyer an email message confirming him/her about this.

At operation 113, contract of sale certificate may be issued between the buyer and the target seller for the item ID indicating a legally binding obligation between them for the item ID and thus to provide a legally safe solution for the selling act between this target seller and the buyer.

In case the result of the operation 109 is that none of the potential sellers agrees on the proposed-price, the potential buyer may be notified in operation 115 by e.g. issuing an automatic rejection-indicator, which may be an email message within a pre-defined time frame indicating that the proposed-price has not been accepted. In that way, the potential buyer does not have to wait for uncertain time frame until he/she will be notified that this first bidding-price has not been accepted.

The method may additionally further include subsequently requesting the buyer of the item ID about seller related feedback data indicating the reliability of the target seller, such as how effective the seller was, how reliable the seller was (e.g. score from 0-10). This seller related feedback data may subsequently be associated to this target seller so as to provide future potential buyers with said feedback data. In the same way, the target seller of the item ID may be requested to enter data about the buyer, how the communication was with the buyer etc. This feedback data about the buyer is subsequently associated to buyer ID data that uniquely identify the buyer so as to provide future target sellers with said feedback data. Accordingly, these feedback data may be utilized on both the buyer as well as the seller sides.

Also, the seller of the item ID may also have to pay some fixed percentage of the selling price to a third party that operates the network-based market place as fee. The method terminates at operation 117.

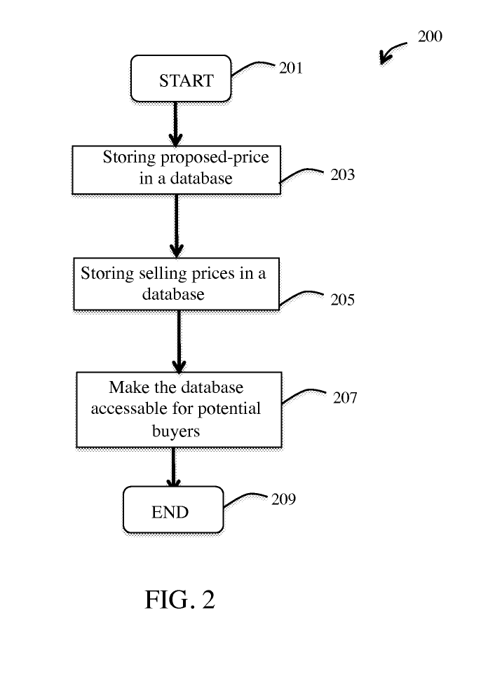

FIG. 2 shows an exemplary embodiment of a method 200 according to the present invention to implement the proposed prices and actual selling prices from the method in FIG. 1 to build up a database.

The method 200 commences at operation 201. At operation 203 the proposed-price discussed in relation to FIG. 1 is associated to the item ID and stored in a database, along with all previous proposed-prices for previous item IDs. In that way, if the item ID was a 42′ plasma TV and the proposed-price was 500$, but this proposed-price was not accepted, this proposed price will be associated to this item ID, i.e. 42′ plasma TV, and stored in the database.

At operation 205, the actual selling price for the item ID is also associated and stored in this database along with previous selling prices for previous item IDs. Referring to the example above, if the proposed-price of 500$ was accepted, this proposed-price will be associated to the item ID (42′ plasma TV) as the actual selling price of the item ID.

At operation 207, the database is utilized as a guidance-database for all future potential buyers in assisting them to find a reasonable/realistic first proposed-price. Therefore, when a potential buyer is provided with a buyer interface he/she can be provided with information about previous proposed-prices and actual selling prices. Assuming that the potential buyer is browsing through various item IDs, e.g. the potential buyer is looking for 42′TVs, he/she may thus be presented with these information about previous proposed-prices and previous selling prices for 42′ plasma TVs (or for 42′ TVs). Based on this information this potential buyer can find a reasonable first proposed-price. The information being presented to the potential buyer may be categorized in more details showing e.g. the lowest proposed-price, the average proposed-price etc. The method terminates at operation 209.

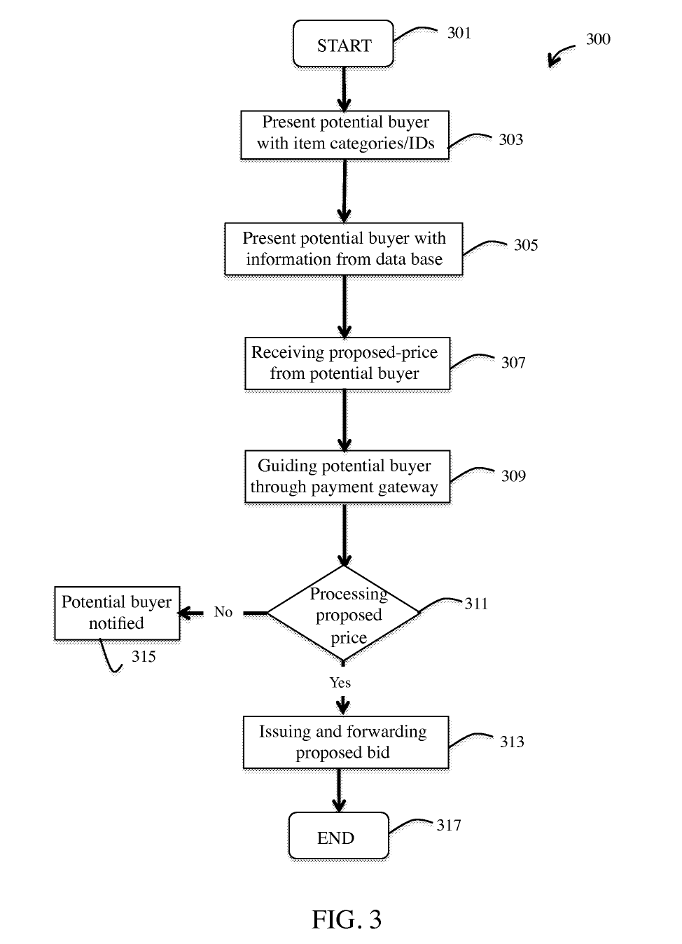

FIG. 3 shows an exemplary embodiment of a method 300 according to the present invention assisting the potential buyer to select the item ID and the proposed price, i.e. the method steps discussed here occur prior to the steps discussed in relation to FIG. 1. The method 300 commences at operation 301. At operation 303 the potential buyer is presented with plurality of item categories each of which includes multiple of item IDs. One item category may e.g. be TVs containing multiple of item IDs may be 32′ TVs, 42′TVs etc., or the item categories by be various TV brands, e.g. one item category is Philips®, another one is Samsung®, yet another one is Sony® etc. In that way, the potential buyer has the opportunity to browse through different item categories and different item IDs.

At operation 305 the potential buyer is presented with information from the database discussed in relation to FIG. 2 indicating previous proposed-prices and information indicating previous selling prices for the item IDs the potential buyer is browsing through. Lets say that the potential buyer selects 42′ TVs, the potential buyer may at that instance be presented with previous proposed prices, e.g. lowest proposed price for 42′ TVs and previous selling price for 42′ TVs. The potential buyer may also be presented with information about special offers for such 42′ TVs and other information that may e.g. indicate the most reasonable proposed-price for the 42′ TVs. It should be noted that this of course applies for all other types of item IDs, e.g. cars, computers, various collective items such as stamps.

At operation 307, the potential buyer selects the item ID and the proposed-price for the item ID and confirms.

At operation 309, the potential buyer is guided through a payment gateway such as PayPal° or credit card interface where the buyer enters detailed information about himself, such as a full name, ID number, address etc. This information is processed at operation 311 for determining whether the potential buyer fulfils a pre-set payment criterion, i.e. a kind of a credit rating is conducted for this potential buyer. If the result of this credit rating is positive the proposed bid is issued in operation 313 and forwarded to the potential sellers discussed in relation to FIG. 1. If however the result of the credit rating is negative the proposed bid is rejected in operation 315 and the potential buyer is notified. The method terminates at operation 317.

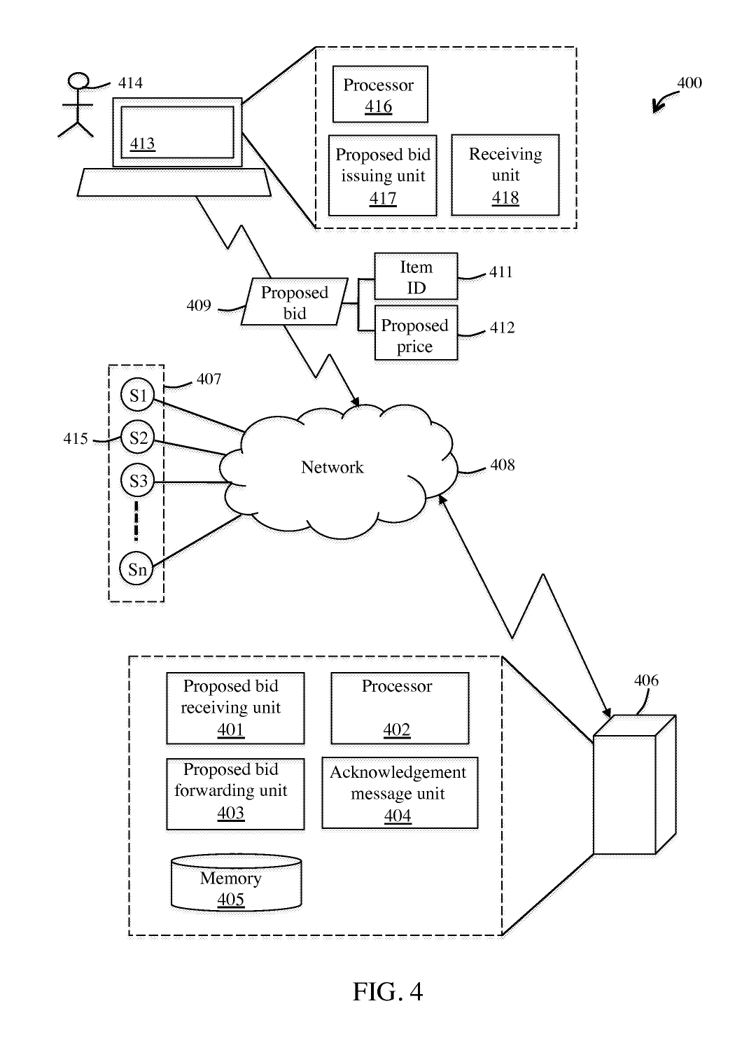

FIG. 4 shows an exemplary embodiment of a computer system 400 according to the present invention for facilitating a purchase of an item on a network-based marketplace.

The example computer system 400 comprises a proposed bid receiving-unit 401, a processor 402, a proposed forwarding unit 403, an acknowledgement message unit 404 and a memory 405. These components may as an example be comprised in a computer system at the seller side, or at a central server 406 that is connected to computer systems at the sellers side via network 408 such as the Internet. For simplicity, in the following it will be assumed that these components are comprised at the central server 406 that operates the wireless communication between the computer at the buyer side and computer at the seller side via the Internet. It should however be noted that this communication could just as well occur directly between the buyers the sellers, i.e. in the absence of such central server.

The proposed bid receiving input-unit 401 receives a proposed bid 409 from a potential buyer 414 to an item ID via network 408 such as the Internet. The proposed bid includes identification data (ID) 411 identifying the item and a proposed-price 412 for the item ID 411. The proposed bid 409 may as an example in a form of an email message containing this proposed-price and item ID information.

The processor 402 processes the proposed bid for identifying potential sellers 407 selling the item ID via the network-based marketplace. This may be done by performing match between the item ID 411 selected by the potential buyer 414 and the plurality of item IDs associated to the plurality of sellers 407. Those sellers having item IDs matching with the item ID selected by the potential buyer, i.e. those sellers that are actually selling this item ID, are considered as being potential sellers. In a network-based marketplace such as in the USA tens or hundreds or even thousands of potential sellers can thus be identified as being sellers that are actually selling this item ID, e.g. a 42′ TV.

It is of course assumed that these potential sellers have computerized their stockroom/warehouse system and are a part of a global network market place in a compatible item ID system so that one common ID is given for a certain item type of product or product category. As an example, a 42′ plasma TV may have a item ID1234, irrespective of the seller meaning that the item ID1234 at the various sellers means a 42′ plasma TV.

The proposed forwarding unit 403 may as an example be a transmitter that transmits the proposed bid to the identified potential sellers that are selling this item ID via the Internet 408. Accordingly, at the seller side the proposed bid may be examined with respect to the proposed-price and e.g. whether they have the requested item ID in stock.

In one embodiment, the proposed bid further includes data identifying how much time the sellers have to respond to the proposed-bid 409, but this may be a fixed time frame, or a time frame that was selected by the potential buyer.

The acknowledgement message unit 404 issues, if a target seller 415 selected from these potential sellers 407 agrees on the proposed-price 412 and thus agrees on the actual selling price for the item ID, an acknowledgement message informing the potential buyer that the target seller has accepted the proposed-price to the item ID. The acknowledgement message unit 404 may as an example be an email message where the target seller 415 sends an email message either directly to the buyer 414 saying that he has accepted the proposed-price 412 for this item ID 411, or to the central server 406 that informs the buyer 414 about that the proposed-price 412 has been accepted.

The memory 405 may be utilized for storing the proposed prices and selling prices from various buyers and associating these information to the item IDs and in that way be utilized to build up a guidance-database for various item IDs with the aim of guiding future potential buyers in selecting proposed bid for various item IDs.

On the buyer side 414, the computer system 400 further comprises a computer interface 413, a processor 416, a proposed bid issuing unit 417 and a receiving unit 418. The computer interface may be an interface presented to the potential buyer 414 at a home computer such as a PC computer or a Laptop computer, or the interface may be presented to the user via a smart phone or any type of portable device such as iPod® touch, where said computer system 400 is an integral part of the home computer or the portable device. The interface is operate by the processor 416 for presenting the potential buyer 414 with at least one item ID from e.g. the database 405 prior to receiving the proposed bid 409 from the potential buyer 414. As discussed in relation to FIG. 2, the item ID may be associated the information from the database 405 indicating previous selling prices or previous proposed prices or both for this item ID. The computer interface 413 may include multiple of main categories, e.g. electronic equipments, cars, collective items etc, and multiple of sub-categories, such as under the category electronic equipment, the sub-category may be phones, TVs, computers etc. If the user selects the TV category, multiple of item IDs (or new sub-categories) may be presented, e.g. 42′TVs, 32′TVs. By selecting the item ID 42′TVs several information may be presented to the buyer indicating previous selling prices, lowest proposed-price, or special offers.

The receiving unit 418 receives from the potential buyer 414 information about the item ID and the proposed-price. This may e.g. be done via keyboard commands on e.g. said PC computer where the potential buyer 414 enters the first proposed-price for a given item ID the potential buyer has selected, or via said portable device via e.g. touch button commands.

The proposed-bid issuing unit 418 issues after receiving the item ID and proposed-price from the potential buyer 414 the proposed bid 409 and subsequently forwards this proposed bid to the server 406.

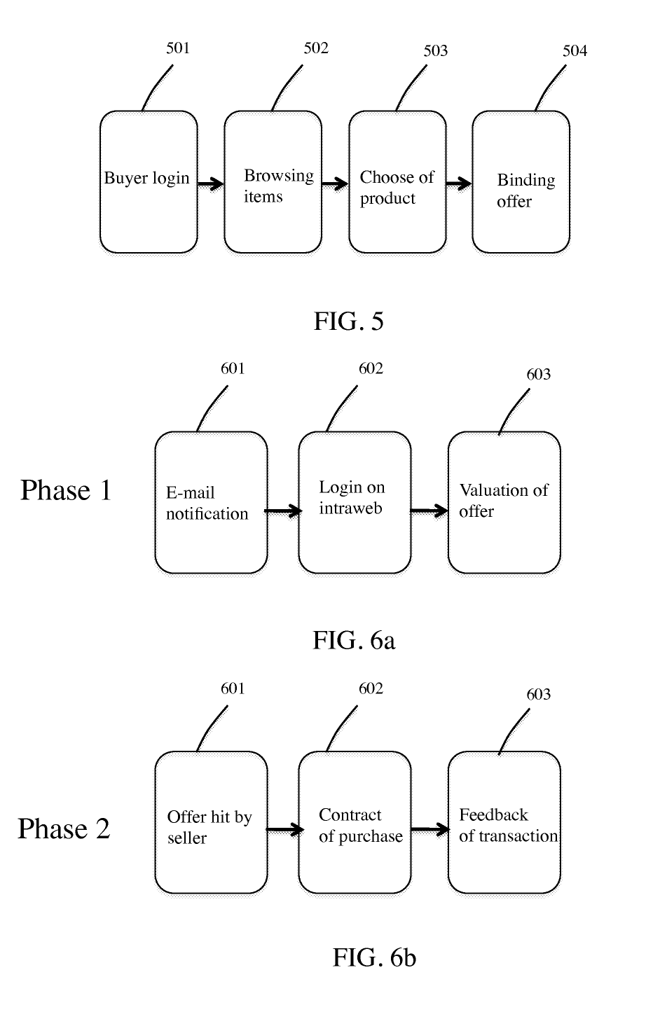

FIG. 5 is a basic diagrammatic presentation of buyers view when purchasing an item on a network-based market place, starting with buyer login 501 where the buyer may be requested for login number and a password to enter said network-based market place, which may be operated by said server 406 shown in FIG. 4 where login 501 is a request to enter the server 406. A list of item categories may be presented to the user allowing the user to browse 502 through various item categories and item IDs. The potential buyer may subsequently select a given item ID 503 and select a proposed price 504 for this given item ID, which is a binding offer.

FIG. 6a,b shows a diagrammatic presentation of sellers view, divided into two phases. In phase 1 (FIG. 6a) a seller receives an email notification 601 of proposed bid, the seller logs himself on intra web to enter said network-based market place that may be operated by a third party 602 to e.g. get more detailed information about the proposed bid such as the item ID and proposed-price and e.g. the time frame the seller has to respond to this proposed bid. This first phase ends with that the seller evaluates 603 the proposed bid. In phase II (FIG. 6b), the seller agrees on the proposed-price 604, a contract of sale certificate 605 is prepared and finally a feedback of transaction 606 information are entered by the seller such as in the scale of 0 to 10 indicating the reliability of the potential buyer.

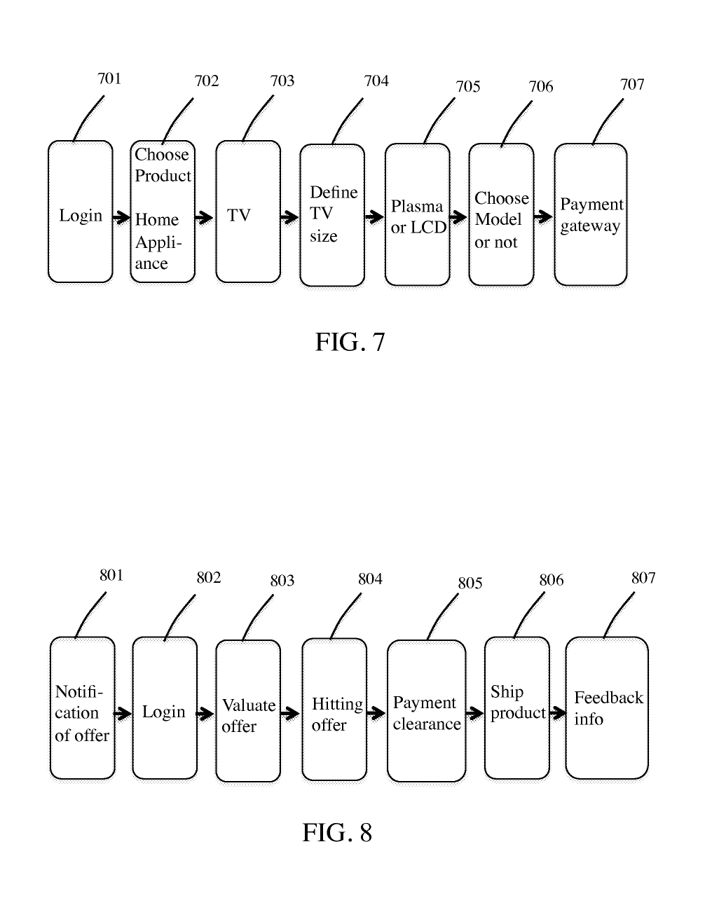

FIG. 7 shows another diagrammatic presentation of the buyer's view depicting in a more detailed way an example of step-by-step approach at the buyer's side. The potential buyer logs 701 into the network-based marketplace by e.g. entering login and password data. The potential buyer is then provided with an interface showing various item categories and item IDs. The potential buyer may as an example choose an item category Home Appliance 702, where under this item category the potential buyer selects TV 703 as a sub-category. The potential buyer may now either select the TV size or define by himself the TV size of interest 704. Subsequently, the potential buyer may select between plasma or LCD TV. The potential buyer may subsequently select between a specific TV brand 706. Accordingly, an item ID is defined specifying that e.g. 42′ Philips® plasma TV has been selected. The potential buyer selects a proposed-price for this item ID and is subsequently guided through a payment gateway 707 wherein the proposed-price is processed for determining whether the potential buyer fulfils pre-set payment criterion.

FIG. 8 shows another diagrammatic presentation of sellers view depicting in a more detailed way an example of step-by-step approach at the sellers side, starting with receiving a notification of a proposed bid 801 via e.g. an email message. The seller now logs in 802 to the network-based marketplace by e.g. entering login and password data. The seller evaluates the proposed-bid 803, and in case the seller agrees on this proposed bid 804 a payment clearance such as PayPal® clearance procedure is initiated 805. After receiving the payment for this item ID it is shipped to the buyer of the item ID 806. Feedback data may subsequently be requested 807 at both the buyer side as well as the seller side.

1. A method to facilitate a purchase of an item on a network-based marketplace, comprising:
i. receiving a proposed bid from a potential buyer to an item, the proposed bid including identification data (ID) identifying said item and a proposed-price for said item ID,
ii. processing said proposed bid so as to identify potential sellers selling said item ID via said network-based marketplace,
iii. forwarding said proposed bid to said identified potential sellers, and
iv. issuing, if a target seller selected from said potential sellers agrees on said proposed-price and thus an actual selling price for said item ID, an acknowledgement message informing said potential buyer that said target seller has accepted said proposed-price to said item ID.

2. A method according to claim 1, further comprising automatically issuing a contract of sale certificate between the buyer and the target seller for said item ID indicating a legally binding obligation between them for said item ID.

3. A method according to claim 1, wherein said proposed bid is further associated with a time frame indicator indicating the time said potential sellers have to respond to said proposed bid.

4. A method according to claim 3, wherein said time frame indicator is selected by said potential buyer.

5. A method according to claim 1, further comprising storing said proposed-price for said item ID in a database along with previous proposed-prices for previous item IDs, the database being utilized as a guidance-database for guiding future potential buyers in selecting proposed-prices for various item IDs.

6. A method according to claim 5, wherein the actual selling price for said item ID and previous item IDs are further associated to said item IDs at said guidance-database.

7. A method according to claim 6, wherein prior to said step of receiving said proposed bid, the method further comprises:
presenting said potential buyer with plurality of item categories each of which includes multiple of item IDs so as to allow said potential buyer to browse through said item categories and said item IDs, said item IDs being associated with information from said guidance-database indicating previous proposed-prices and information indicating previous selling prices for said item IDs, and
receiving from said potential buyer said proposed-price for said item ID, where by confirming said proposed-price for said item ID by the potential buyer,
issuing and forwarding said proposed bid.

8. A method according to claim 7, wherein when browsing through said item categories the information from said guidance-database about the item IDs being browsed are automatically triggered and presented to the user.

9. A method according to claim 1, wherein prior to said step of receiving said proposed bid, the method further comprises guiding said potential buyer through a payment gateway wherein said proposed-price is processed for determining whether the potential buyer fulfils pre-set payment criterion, where in case said pre-set payment criterion is fulfilled said potential buyer becomes committed to said proposed-price for said item ID.

10. A method according to claim 1, wherein said step of processing the proposed bid comprises performing a match between said item ID selected by the potential buyer and said plurality of item IDs associated to said plurality of sellers, wherein those sellers having item IDs matching with said item ID selected by the potential buyer are considered as being said potential sellers.

11. A method according to claim 1, wherein if none of said potential sellers agree on said proposed bid an automatic rejection-indicator is issued and forwarded to said potential buyer within a pre-defined time frame indicating that said proposed bid has not been accepted.

12. A method according to claim 1, further comprising requesting said buyer of said item ID for seller related feedback data indicating the reliability of the target seller, said seller related feedback data subsequently being associated to said target seller.

13. A method according to claim 1, further comprising requesting said target seller of said item ID about buyer related feedback data indicating the reliability of the buyer, said buyer related feedback data subsequently being associated to buyer ID data uniquely identifying the buyer of said item ID.

14. A machine-readable medium having stored thereon data representing sequences of instructions, the sequences of instructions which, when executed by a processor, cause the processor to perform the steps of:
i. receiving a proposed bid from a potential buyer to an item, the proposed bid including identification data (ID) identifying said item and a proposed-price for said item ID,
ii. processing said proposed bid so as to identify potential sellers selling said item ID via said network-based marketplace,
iii. forwarding said proposed bid to said identified potential sellers, and
iv. issuing, if a target seller selected from said potential sellers agrees on said proposed-price and thus an actual selling price for said item ID, an acknowledgement message informing said potential buyer that said target seller has accepted said proposed-price to said item ID.

15. A computer system for facilitating a purchase of an item on a network-based marketplace, comprising:
i. a proposed bid receiving input-unit for receiving a proposed bid from a potential buyer to an item, the proposed bid including identification data (ID) identifying said item and a proposed-price for said item ID,
ii. a processor for processing said proposed bid so as to identify potential sellers selling said item ID via said network-based marketplace, and
iii. a proposed bid forwarding unit for forwarding said proposed bid to said identified potential sellers,
iv. a acknowledgement message issuing unit for issuing, if a target seller selected from said potential sellers agrees on said proposed-price and thus an actual selling price for said item ID, an acknowledgement message informing said potential buyer that said target seller has accepted said proposed-price to said item ID.

16. A computer system according to claim 15, further comprising a memory for storing said proposed price and said selling price and associating it to said item ID so as building up a guidance-database for various item IDs adapted for guiding future potential buyers in selecting proposed bid for various item IDs.

17. A computer system according to claim 16, further comprising:
a computer interface operate by a processor for presenting said potential buyer with at least one item ID prior to receiving said proposed bid from said potential buyer, said at least one item ID being associated with information from said guidance-database indicating previous selling prices or previous proposed-proposed prices or both for said item ID,
a receiving unit for receiving from said potential buyer said proposed-price for said item ID, and
proposed bid issuing unit for, when receiving an input command from said potential buyer confirming said proposed bid for said item ID by the potential buyer, issuing and forwarding said proposed bid and forwarding said proposed bid.
